(19) United States
(12) Patent Application Publication
(10) Pub. No.: US 2012/0141632 A1
(43) Pub. Date: Jun. 7, 2012

(54) PRETZEL-BAGEL AND METHOD OF MANUFACTURING THEREOF

(75) Inventors: John McDonnell, Yardley, PA (US); Gary Volovnik, JR., Perkasie, PA (US); Cindy Raman, Park Ridge, NJ (US)

(73) Assignee: Bimbo Hungria Vagyonkezelo Zartkoruen Mukodo Reszvenytarsasag, Ujlengyel (HU)

(21) Appl. No.: 12/958,731

(22) Filed: Dec. 2, 2010

(51) Int. Cl. A21D 13/00; A21D 15/00

(52) U.S. Cl. 426/26; 426/94

(57) ABSTRACT

A method of manufacturing an edible product, and a baked product itself, is provided that includes mixing and kneading ingredients having wheat flour, water, sugar, salt, mono and diglycerides, yeast, calcium propionate, sorbic acid, cornmeal, guar gum, wheat, gluten, and citric acid into a dough. The dough is then formed into a uniform rod having end portions. The end portions are then connected to form a circular-shaped element. The circular-shaped element is then fermented to a desired size and is then boiled in a sodium hydroxide bath for a period of time to produce a color that is between a yellow and an orange hue. The circular-shaped element is then baked, followed by spraying the circular-shaped element with a preservative formulation, and then cooling the circular-shaped element.

### FIELD

The present disclosure relates to baked goods, and in particular, bagels, pretzels, and the like, and methods of making the same.

### BACKGROUND

The statements in this section merely provide background information related to the present disclosure and may not constitute prior art.

Generally, bagels are made by a process that creates a ring-shaped product with a relatively dense bread and a hard outer crust. Bagels are made from a yeast dough and are first boiled in water to close the pores of the dough. The bagels are then baked in an oven to create the hard outer crust, which is generally golden brown in color. There are a variety of bagel products having, for example, different shapes and various fillings and/or coatings. Methods of creating different bagel forms are continually being developed in order to meet the needs of consumers and to differentiate baked goods on the market.

### SUMMARY

In one form of the present disclosure, a method of manufacturing an edible product is provided that comprises mixing and kneading ingredients including wheat flour, water, sweetener, salt, an emulsifier, yeast, calcium propionate, polyunsaturated fat, wheat, and gluten into a dough. The dough is then formed into a shape, and the shape is fermented to a desired size. The shape is then boiled in a sodium hydroxide bath for a period of time to produce a desired color. Then, the shape is baked and then sprayed with a preservative formulation, followed by a cooling step.

In another form, a method of manufacturing an edible product is provided that comprises mixing and kneading ingredients including wheat flour, water, sugar, salt, mono and diglycerides, yeast, calcium propionate, sorbic acid, cornmeal, guar gum, wheat, gluten, and citric acid into a dough. The dough is then formed into a uniform rod having end portions. The end portions are then connected to form a circular-shaped element. The circular-shaped element is then fermented to a desired size and is then boiled in a sodium hydroxide bath for a period of time to produce a color that is between a yellow and an orange hue. The circular-shaped element is then baked, followed by spraying the circular-shaped element with a preservative formulation, and then cooling the circular-shaped element.

In still another method of the present disclosure, a method of manufacturing an edible product is provided that comprises mixing and kneading ingredients to create a bagel-like dough, forming the dough into a shape, fermenting the shape to a desired size, coating the shape with a sodium hydroxide solution for a period of time to produce a desired color, baking the shape, and cooling the shape.

In another form, a baked product is provided that comprises wheat flour, water, sweetener, salt, an emulsifier, yeast, calcium propionate, polyunsaturated fat, wheat, and gluten, the baked product being boiled a sodium hydroxide bath prior to baking, and the baked product having an outer surface that is coated with a preservative formulation.

In yet another form, a baked product is provided that comprises wheat flour, water, sugar, salt, mono and diglycerides, yeast, calcium propionate, sorbic acid, cornmeal, guar gum, wheat, gluten, and citric acid, the baked product being boiled a sodium hydroxide bath prior to baking, and the baked product having an outer surface that is coated with a preservative formulation.

Further still, a baked product is provided that comprises a bagel-like dough, the baked product being coated with a sodium hydroxide solution prior to baking.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

The present disclosure provides a unique and tasteful product that combines the features of bagels and pretzels into a single, edible product, hereinafter referred to as a “pretzel-bagel” or “bagel-pretzel.” Generally, a traditional bagel dough is formed and is boiled in a sodium hydroxide (or salt) bath, rather than in just water, during the manufacturing process in order to produce a bagel that has the salty flavor of a pretzel. In other words, a pretzel-style caustic boiling or heated caustic solution is used to dip a bagel into, or to coat a bagel, in order to achieve a bagel that tastes like a pretzel-dough product. Such a baked, or edible product has not before been seen or produced and can provide an exciting new product for consumers worldwide.

In one form of the present disclosure, ingredients are mixed and kneaded to form the bagel-like dough. The ingredients include wheat flour, water, sweetener, salt, an emulsifier, yeast, calcium propionate, polyunsaturated fat, wheat, and gluten. The sweetener can be sugar or corn sweetener, among others, and the polyunsaturated fat is selected from the group consisting of sorbic acid and potassium sorbate. Additional ingredients may include, but are not limited to, guar gum, cornmeal, and citric acid. The emulsifier is selected from the group consisting of mono and diglycerides, Sodium Stearoyl Lactylate (SSL), and Diacetyl Tartaric Acid Esters of Monoglycerides (DATEM). In one form, the dough is mixed and kneaded for between approximately three (3) minutes and approximately five (5) minutes.

The composition of the dough, in one form, is shown below in Table 1. This composition is merely exemplary and should not be construed as limiting the scope of the present disclosure.

TABLE 1

| | Weight, based on |
|---|---|
| Ingredient | 100 pounds of flour |
| Wheat Flour | 100 |
| Water | 60-90 |
| Sugar | 0-20 |
| Salt | 0-10 |
| Mono and diglycerides | 0-5 |
| Yeast | 0-5 |
| Calcium propionate | 0-5 |
| Sorbic acid | 0-5 |
| Cornmeal | 0-5 |
| Guar gum | 0-2 |
| Wheat, gluten | 0-10 |
| Citric acid | 0-12 |

After the dough is mixed and kneaded, it is formed into a shape. In one exemplary form of the present disclosure, the shape is formed into a uniform rod having end portions, and the end portions are connected to form a closed shape. The closed shape may be circular or ring-shaped, among other shapes. It should be understood that any shape, including the traditional circular or ring shape of a bagel, or even a bar shape, may be employed while remaining within the scope of the present disclosure.

After the dough is formed into the desired shape, it is fermented to a desired size. In one form of the present disclosure, the fermentation step is from between approximately ten (10) minutes and approximately ninety (90) minutes. It should be understood that other fermentation periods may be employed while remaining within the scope of the present disclosure.

Next, the fermented shape is coated with a sodium hydroxide solution in order to impart the distinctive pretzel flavor. The sodium hydroxide solution has a concentration of sodium hydroxide to water of approximately less than or equal to ten (10) percent (%), and in one form is between approximately 1.5% and approximately 3.0%. In one form, the shape is boiled in a sodium hydroxide bath for a period of time to produce a desired color. In one form, the boiling is from between approximately five (5) to approximately eighty (80) seconds. In another form, the shape is passed under a “waterfall” sodium hydroxide solution, which may be at room temperature in one form of the present disclosure. The desired color, in one form, is between a yellow and an orange hue.

The shape is then baked, and in one form, between approximately five (5) and approximately fifteen (15) minutes at between approximately three-hundred (300) and approximately five-hundred (500) degrees Fahrenheit.

After baking, the shape is sprayed with a preservative formulation in order to increase shelf-life. The preservative formulation is generally less than or equal to approximately three (3) grams per bagel-pretzel.

Finally, the shape is cooled to complete the manufacturing process.

As used herein, the term “bagel-like” shall be construed to mean a relatively dense yeast-based dough that is then baked to form the generally golden brown, harder outer crust. Bagel dough, in contrast to, for example, a pretzel dough, uses a hard flour, or a flour that has from approximately twelve (12) to approximately fourteen (14) percent protein. Pretzel dough uses a soft flour (often a pastry flour) that has from approximately seven (7) to approximately nine (9) percent protein. Accordingly, the hard flour of a bagel dough creates a hard and chewy bagel, whereas the soft flour of a pretzel dough creates a soft bite in the final, baked product. Therefore, the term “bagel-like” shall further be construed to mean a relatively dense yeast-based dough have a hard flour from approximately twelve (12) to approximately fourteen (14) percent protein.

It should be noted that the disclosure is not limited to the various forms described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A method of manufacturing an edible product comprising:
mixing and kneading ingredients comprising wheat flour, water, sweetener, salt, an emulsifier, yeast, calcium propionate, polyunsaturated fat, wheat, and gluten into a dough;
forming the dough into a shape;
fermenting the shape to a desired size;
boiling the shape in a sodium hydroxide bath for a period of time to produce a desired color;
baking the shape;
spraying the shape with a preservative formulation; and
cooling the shape.

2. The method according to claim 1, wherein the sweetener is selected from the group consisting of sugar and corn sweetener.

3. The method according to claim 1, wherein the polyunsaturated fat is selected from the group consisting of sorbic acid and potassium sorbate.

4. The method according to claim 1, wherein the ingredients further comprise guar gum.

5. The method according to claim 1, wherein the ingredients further comprise cornmeal.

6. The method according to claim 1, wherein the ingredients further comprise citric acid.

7. The method according to claim 1, wherein the emulsifier is selected from the group consisting of mono and diglycerides, Sodium Stearoyl Lactylate (SSL), and Diacetyl Tartaric Acid Esters of Monoglycerides (DATEM).

8. The method according to claim 1, further comprising the steps of:
forming the shape into a uniform rod having end portions; and
connecting the end portions of the uniform rod to form a closed shape.

9. The method according to claim 8, wherein the closed shape is a circle.

10. The method according to claim 1, wherein the mixing and kneading is between approximately 3 minutes and approximately 5 minutes.

11. The method according to claim 1, wherein the fermentation is between approximately 10 minutes and approximately 90 minutes.

12. The method according to claim 1, wherein the boiling is between approximately 5 to approximately 80 seconds.

13. The method according to claim 1, wherein the desired color is between a yellow and an orange hue.

14. The method according to claim 1, wherein the sodium hydroxide bath has a concentration of sodium hydroxide to water of approximately less than or equal to 10%.

15. The method according to claim 14, wherein the concentration of sodium hydroxide to water is between approximately 1.5% and approximately 3.0%.

16. The method according to claim 1, wherein the baking is between approximately 5 and approximately 15 minutes at between approximately 300 and approximately 500 degrees Fahrenheit.

17. The method according to claim 1, wherein the preservative formulation is less than or equal to approximately 3 grams.

18. A method of manufacturing an edible product comprising:
mixing and kneading ingredients comprising wheat flour, water, sugar, salt, mono and diglycerides, yeast, calcium propionate, sorbic acid, cornmeal, guar gum, wheat, gluten, and citric acid into a dough;
forming the dough into a uniform rod having end portions;
connecting the end portions of the uniform rod to form a circular-shaped element;
fermenting the a circular-shaped element to a desired size;
boiling the circular-shaped element in a sodium hydroxide bath for a period of time to produce a color that is between a yellow and an orange hue;
baking the circular-shaped element;
spraying the circular-shaped element with a preservative formulation; and
cooling the circular-shaped element.

19. A method of manufacturing an edible product comprising:
mixing and kneading ingredients to create a bagel-like dough;
forming the dough into a shape;
fermenting the shape to a desired size;
coating the shape with a sodium hydroxide solution for a period of time to produce a desired color;
baking the shape; and
cooling the shape.

20. The method according to claim 19, further comprising spraying the shape with a preservative formulation prior to cooling.

21. The method according to claim 19, wherein the coating comprises boiling in a sodium hydroxide bath.

22. The method according to claim 19, wherein the coating comprises a waterfall arrangement.

23. A baked product comprising wheat flour, water, sweetener, salt, an emulsifier, yeast, calcium propionate, polyunsaturated fat, wheat, and gluten, the baked product being boiled a sodium hydroxide bath prior to baking, and the baked product having an outer surface that is coated with a preservative formulation.

24. The baked product according to claim 23, wherein the sweetener is selected from the group consisting of sugar and corn sweetener.

25. The baked product according to claim 23, wherein the polyunsaturated fat is selected from the group consisting of sorbic acid and potassium sorbate.

26. The baked product according to claim 23, wherein the ingredients further comprise guar gum.

27. The baked product according to claim 23, wherein the ingredients further comprise cornmeal.

28. The baked product according to claim 23, wherein the ingredients further comprise citric acid.

29. The baked product according to claim 23, wherein the emulsifier is selected from the group consisting of mono and diglycerides, Sodium Stearoyl Lactylate (SSL), and Diacetyl Tartaric Acid Esters of Monoglycerides (DATEM).

30. The baked product according to claim 23, wherein the baked product is a circular shape.

31. A baked product comprising wheat flour, water, sugar, salt, mono and diglycerides, yeast, calcium propionate, sorbic acid, cornmeal, guar gum, wheat, gluten, and citric acid, the baked product being boiled a sodium hydroxide bath prior to baking, and the baked product having an outer surface that is coated with a preservative formulation.

32. A baked product comprising a bagel-like dough, the baked product being coated with a sodium hydroxide solution prior to baking.

33. The baked product according to claim 32, wherein the baked product has an outer surface that is coated with a preservative formulation after baking.
